(19) United States
(12) Patent Application Publication
(10) Pub. No.: US 2016/0169265 A1
(43) Pub. Date: Jun. 16, 2016

(54) NUT RETAINER

(71) Applicant: C P WITTER LIMITED, Flintshire (GB)

(72) Inventor: Jonathan Edwards, Shropshire (GB)

(73) Assignee: C P Witter Limited, Flintshire (GB)

(21) Appl. No.: 14/908,050

(22) PCT Filed: Jul. 25, 2014
(86) PCT No.: PCT/GB2014/052283

§ 371 Date: Jan. 27, 2016

(30) Foreign Application Priority Data
Jul. 30, 2013 (GB) 1313608.0

(51) Int. Cl. F16B 37/04

(52) U.S. Cl. CPC F16B 37/044

(57) ABSTRACT

A retainer device, for positioning a threaded nut relative to a bore in a component for attachment of a threaded bolt, having a housing member for receiving a threaded nut and a support member that is attachable to the housing member so as to attach the housing member to the component by clamping the component between opposed surfaces of the housing member and the support member, wherein the support member is attachable to the housing member in a plurality of positions in which the distance between the opposed surfaces of the support member and the housing member is varied.

This invention concerns a retainer device for positioning a threaded nut relative to an aperture in a component.

Vehicle towbars, for example, widely use fixed nuts or threaded inserts that are welded or fixed to the towbar. Typically they are welded to towbar components to align with a hole in the component. The fixed nut or threaded insert is used commonly because there is limited access for using a loose nut and bolt. For example, a tow bar may be supported at the rear of a vehicle by connection to chassis side rails. The tow bar has end plates to each of which one end of a respective side arm is fastened the other end being connected, in turn, to a respective chassis rail of the vehicle. Each end plate has an aperture for receipt of a bolt for connecting the side arm to the tow bar, with a threaded nut being welded or similarly fixed to the reverse face of the end plate, i.e. inside the towbar itself.

A problem with using a welded or otherwise fixed threaded nut or insert is that when painted the threads of the nut or insert are contaminated by the paint, such as a polyester powder coating. This leads to bolts becoming obstructed when inserted into the nuts, whereby the joint can be ineffective and fail. For example the bolt and nut may become cross-threaded resulting in a jam that prevents connection. Replacement of the nut is generally not possible as it is impossible to access without cutting through the tow bar or removing the end plates (which are integrally formed with the towbar by for example welding or the like). The whole towbar thus has to be replaced.

Thread protection or masking using silicone rubber inserts in the nuts is possible and at least partially effective. However, after painting it is necessary to carry out a further operation of cleaning the threads with a tap. This is a slow and hence costly process.

Another complication can arise from any pre-treatment of components prior to painting, such as shot blasting. This pre-treatment provides a better surface for painting, so that an excellent paint finish can be achieved. However, blast treatment materials can become lodged in threads and subsequently become embedded in the paint. These blast grit particles are extremely hard and make the removal of paint from threads even more difficult, so that thread jamming is almost inevitable.

In order to address this problem, GB2464308 (C P Witter Limited) discloses a fastener for a nut comprising a cage for receiving a nut, wherein the cage has a pair of tongues that extend outwardly from the cage. Each tongue has an outwardly extending lip, provided at the end of the tongue. An inwards protrusion is provided on each of the tongues for retaining the nut in the cage, for example when the cage is turned over in order to fit the nut and fastener to an aperture of a component.

In use a nut is inserted into the cage, passed the protrusions on the tongues. The tongues of the fastener are inserted through an aperture in a component and the lips at the ends of the tongues retain the fastener in the aperture by overlapping the component beyond the ends of the aperture. Accordingly, the fastener retains the nut in a position aligned with the aperture in the component. This allows a threaded nut to be attached to a component after a finishing treatment.

Another component may then be attached to the component by aligning an aperture in the other component with the aperture in the component and passing a bolt through the apertures, from the other side of the components to the fastener, and screwing the bolt into the nut. As it does so, the nut moves past the protrusions on each of the tongues, which causes the tongues to deflect outwards, thereby forcing them tightly against the walls of the component that define the aperture. This holds the fastener securely in place over the aperture.

However, the fastener suffers from the disadvantage that it is unable to be used with a wide range of different thicknesses of components.

An object of the present invention is to provide a means for retaining a threaded nut relative to a bore in a component after a finishing treatment that is able to accommodate a relatively wide range of thicknesses of the component.

According to a first aspect of the invention there is provided a retainer device, for positioning a threaded nut relative to a bore in a component for attachment of a threaded bolt, comprising a housing member for receiving a threaded nut and a support member that is attachable to the housing member so as to attach the housing member to the component by clamping the component between opposed surfaces of the housing member and the support member, wherein the support member is attachable to the housing member in a plurality of positions in which the distance between the opposed surfaces of the support member and the housing member is varied.

This is advantageous in that the distance between the opposed surfaces of the housing member and the support member, that attach the housing member to the component by clamping the component between the surfaces, can be varied so as to accommodate different thicknesses of the component.

Preferably the housing member comprises a first engagement member and the support member comprises a second engagement member, wherein the first and second engagement members are engageable with each other in a plurality of positions such that the support member is attachable to the housing member in said plurality of positions.

Preferably the first engagement member comprises at least one channel and the second engagement member comprises at least one tongue that is slidably receivable within the at least one channel. Alternatively, the first engagement member may comprise the at least one tongue and the second engagement member may comprise the at least one channel.

The at least one channel preferably comprises first and second channels and the at least one tongue preferably comprises first and second tongues that are slidably receivable within the first and second channels respectively.

Preferably the at least one channel is provided with a plurality of formations distributed along the length of the channel and the at least one tongue is provided with at least one co-operating formation that is engageable with the plurality of formations such that the support member is attachable to the housing member in said plurality of positions. Alternatively, the at least one tongue may be provided with a plurality of formations distributed along the length of the tongue and the at least one channel provided with at least one co-operating formation that is engageable with the plurality of formations such that the support member is attachable to the housing member in said plurality of positions.

The plurality of formations may be a plurality of teeth or grooves. The at least one co-operating formation may be at least one groove or tooth. The at least one co-operating formation may be a plurality of said co-operating formations, distributed in a length direction of the at least one channel or tongue as appropriate.

Preferably the support member is attachable to the housing member such that the opposed surfaces of the housing member and support member are movable towards each other, to said plurality of positions, but are prevented from moving away from each other by the engagement of the first and second engagement members. This is advantageous in that is allows the distance between the opposed surfaces of the housing member and support member to be varied, so as to accommodate different thicknesses of the component, while still maintaining the clamping force of the opposed surfaces on the component so as to retain the housing member on the component.

Where the first engagement member comprises said at least one channel, the at least one channel is preferably formed in a side wall of the housing member. Where the first engagement member comprises first and second channels, the first and second channels are preferably provided on opposed side walls of the housing member.

Where the second engagement member comprises said at least one tongue, the at least one tongue preferably extends from the opposed surface of the support member. Where the second engagement member comprises first and second said tongues, the first and second tongues preferably extend from opposed sides of said opposed surface of the support member.

Preferably the support member is provided with an aperture arranged such that a shaft of a bolt may pass through the aperture and into engagement with a nut received within the housing member. Preferably said aperture is provided in said opposed surface of the support member.

Preferably the support member comprises a plate and a surface of the plate forms said opposed surface of the support member. Preferably the at least one tongue extends from the plate.

Preferably the housing member comprises a formation that is engageable with the bolt as the bolt is screwed into a nut received in the housing member such that the housing member is attached to the bolt.

Preferably the formation is a bore. Preferably the bore has a generally curved cross sectional shape provided with at least one lobed portion. Preferably the bore is provided with a plurality of said lobed portions distributed in the circumferential direction of the cross sectional shape of the bore.

Preferably the housing member is provided with at least one protrusion for engagement with the bore in the component so as to prevent rotation of the housing member relative to the component when a bolt is screwed into the nut. Preferably the at least one protrusion comprises first and second protrusions. Preferably the first and second protrusions are opposed to each other.

Preferably the housing member is provided with an aperture through which a surface of a nut received within the housing member is contactable with the component. Preferably the aperture is arranged such that a nut is receivable into the housing member through the aperture.

Preferably the aperture is provided in said opposed surface of the housing member.

Preferably the housing member forms an enclosure that substantially encloses a nut received within the housing member apart from a surface of the nut that contacts the component through the aperture. This is advantageous in that it prevents corrosion of the nut.

Preferably the housing member is made from a corrosion resistant material. Preferably the housing member is made from High-density polyethylene (HDPE). The housing member may be made from any material suitable for injection moulding such as Acrylonitrile-Butadiene-Styrene ABS, Nylon PA, Polycarbonate PC, Polypropylene PP, Polystyrene GPPS, or Light metal alloys, for example.

According to a second aspect of the invention there is provided a fastener assembly comprising a retainer device according to the first aspect of the invention and a threaded nut received in the housing member of the retainer device.

Where the housing member is provided with said aperture, preferably a surface of the nut that is contactable with the component through the aperture is provided with at least one protrusion for receipt within a bore in the component so as to prevent rotation of the nut relative to the component when a bolt is screwed into the nut. Preferably said surface of the nut is provided with first and second said protrusions. Preferably the first and second protrusions are opposed to each other.

Preferably the nut is a square nut. However, the nut may have any other suitable shape.

According to a third aspect of the invention there is provided a component fitted with a fastener assembly according to the second aspect of the invention, wherein a bore is provided in the component that extends from a first surface to a second surface of the component, the housing member of the fastener assembly is mounted to the first surface of the component such that a surface of the housing member contacts said first surface and the support member of the fastener assembly is attached to the housing member such that a surface of the support member is opposed to the surface of the housing member and contacts the second surface of the component such that the housing member is attached to the component by clamping the component between said opposed surfaces of the housing member and support member.

Preferably the support member is passed through the bore in the component, from the side of the second surface of the component.

Where the housing member is provided with said aperture, preferably a nut received within the housing member contacts the first surface of the component through the aperture in the housing member.

Preferably the bore of the component has at least one first section that is shaped to receive the at least one protrusion of the housing member so as to prevent rotation of the housing member relative to the component when a bolt is screwed into the nut. Preferably the bore has first and second said first sections that are shaped to receive the first and second protrusions of the housing member respectively so as to prevent said rotation.

Preferably the bore of the component has at least one second section that is shaped to receive the at least one protrusion on said surface of the nut so as to prevent rotation of the nut relative to the component when a bolt is screwed into the nut. Preferably the bore has first and second said second sections that are shaped to receive the first and second protrusions of on said surface of the nut respectively so as to prevent said rotation.

According to a fourth aspect of the invention there is provided a component assembly comprising a component fitted with a fastener assembly according to the third aspect of the invention, said component forming a first component, and a second component provided with a bore that extends from a first surface to a second surface of the component, wherein the first and second components are arranged such that the second surface of the first component is adjacent and opposed to the first surface of the second component and their respective bores are in alignment, wherein a bolt passes from the side of the second surface of the second component through the aligned bores into engagement with the nut received within the housing member.

Where the support member comprises said plate, the plate may be provided between the second surface of the first component and the first surface of the second component.

Preferably the threaded bolt is engaged with the formation of the housing member.

According to a fifth aspect of the invention there is provided a method of attaching a fastener assembly according to the second aspect of the invention to a component provided with a bore that passes from a first surface to a second surface of the component, the method comprising the steps of mounting the housing member to the first surface of the component, attaching the support member to the housing member and adjusting the separation of the opposed surfaces of the housing member and support member such that the housing member is attached to the component by clamping the component between the opposed surfaces of the housing member and the support member.

Preferably the support member is passed through the bore in the component from the side of the second surface of the component.

Preferably the at least one protrusion of the housing member is received within the at least one first section of the bore in the component.

Preferably the at least one protrusion on the nut is received within the at least one second section of the bore in the component.

The component may be a plate, block, or any other component. Preferably the component is a component of a tow bar. Preferably the component is a plate of a tow bar. Preferably the component is a side plate of a tow bar.

According to a sixth aspect of the invention there is provided a method of attaching a first component to a second component comprising the method of the fifth aspect of the invention, wherein the component forms the first component and the method further comprises providing a second component that has a bore that extends from a first surface to a second surface of the component, arranging the first and second components such that a second surface of the first component is adjacent and opposed to the first surface of the second component and their respective bores are in alignment, and passing a bolt from the side of the second surface of the second component through the aligned bores into engagement with the nut received within the housing member.

Where the support member comprises said aperture, preferably a shaft of the bolt is passed through the aperture in the support member into the bore in the first component.

Preferably the bolt is engaged with the formation of the housing member.

The second component may be a plate, block, or any other component. Preferably the second component is a component of a vehicle. Preferably the second component is a component of a vehicle chassis.

All of the features described herein may be combined with any of the above aspects, in any combination.

A specific embodiment of the present invention will now be described, by way of example only, with reference to the accompanying drawings in which:

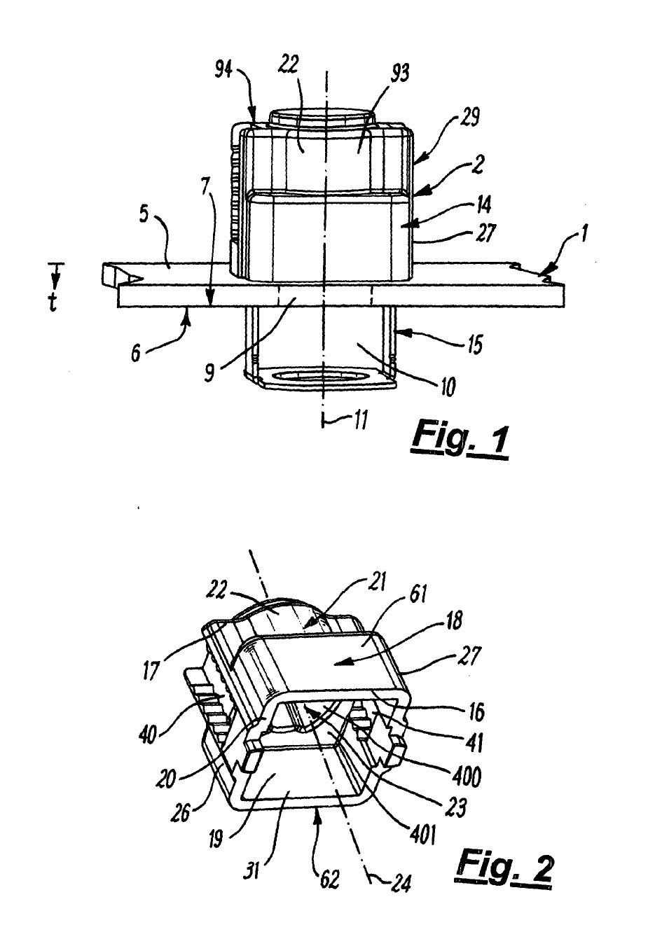

FIG. 1 shows a front perspective view of a first component partially fitted with a fastener assembly according to the present invention;

FIG. 2 shows a lower front perspective view of a housing member of the fastener assembly shown in FIG. 1, with a nut of the fastener assembly removed for illustrative purposes;

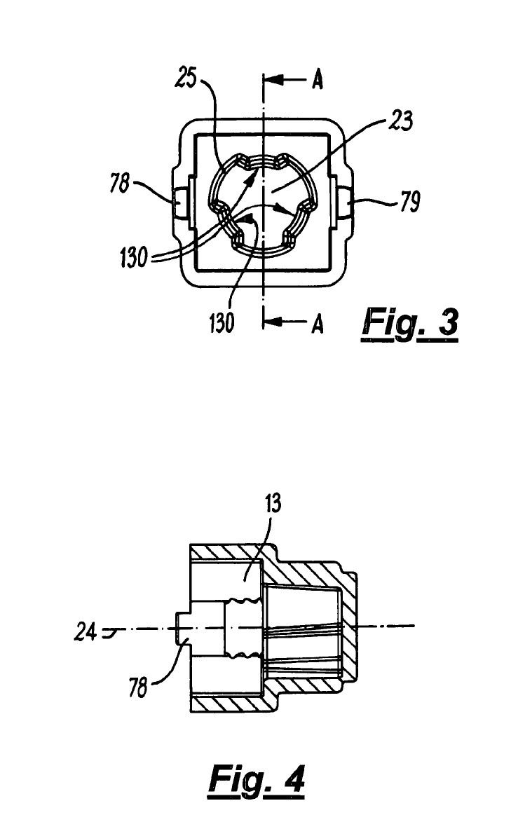

FIG. 3 shows an under plan view of the housing member shown in FIG. 2;

FIG. 4 shows a cross-sectional view of the housing member shown in FIG. 3 taken along the line A-A in FIG. 3 where a nut is received within a nut receiving part of the housing member;

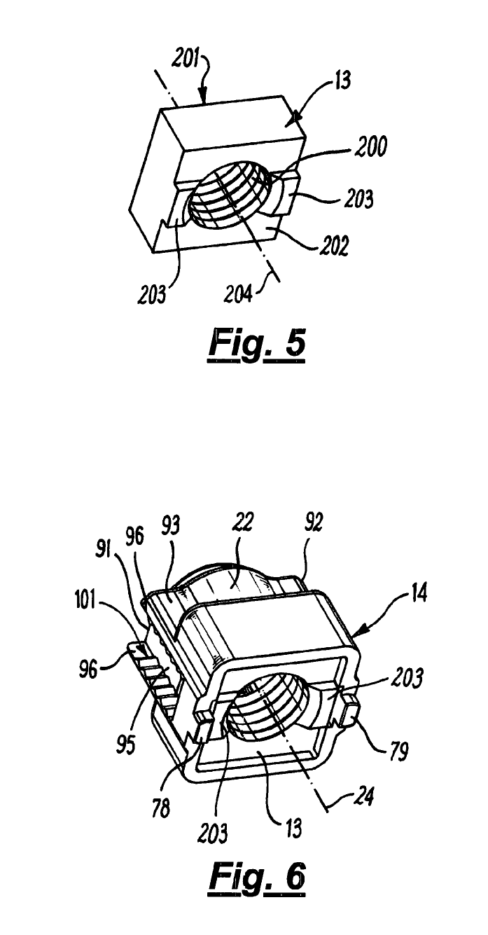

FIG. 5 shows a nut of the fastener assembly shown in FIG. 1;

FIG. 6 shows a view corresponding to that of FIG. 2 but where the nut of FIG. 5 is received within the housing member of FIG. 2;

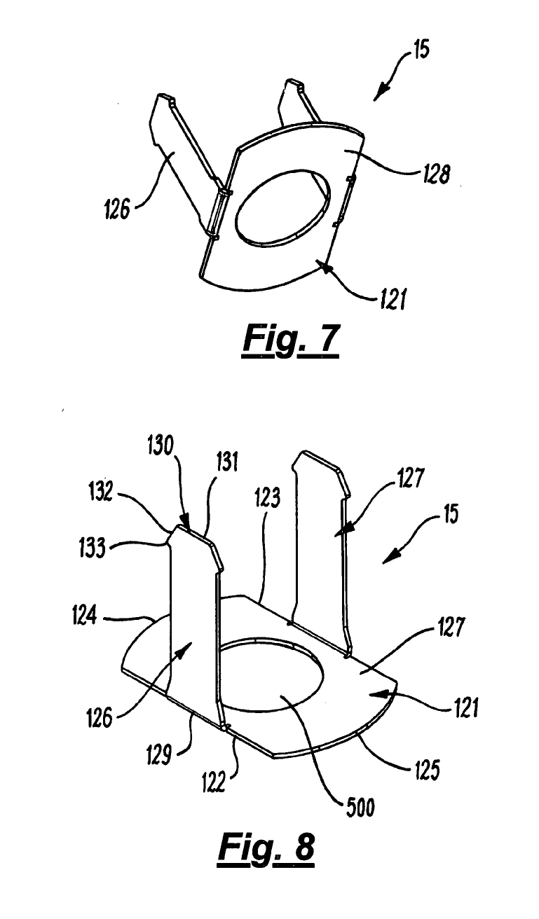

FIG. 7 shows a lower perspective view of a support member of the fastener assembly shown in FIG. 1;

FIG. 8 shows an upper perspective view of the support member shown in FIG. 7;

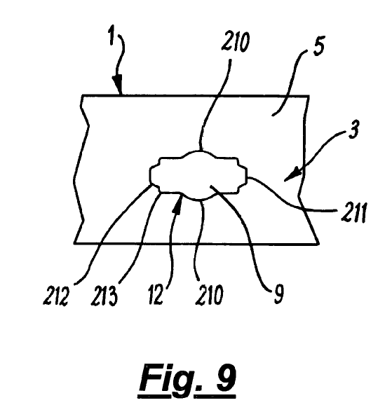

FIG. 9 shows a plan elevational view of the first component of FIG. 1;

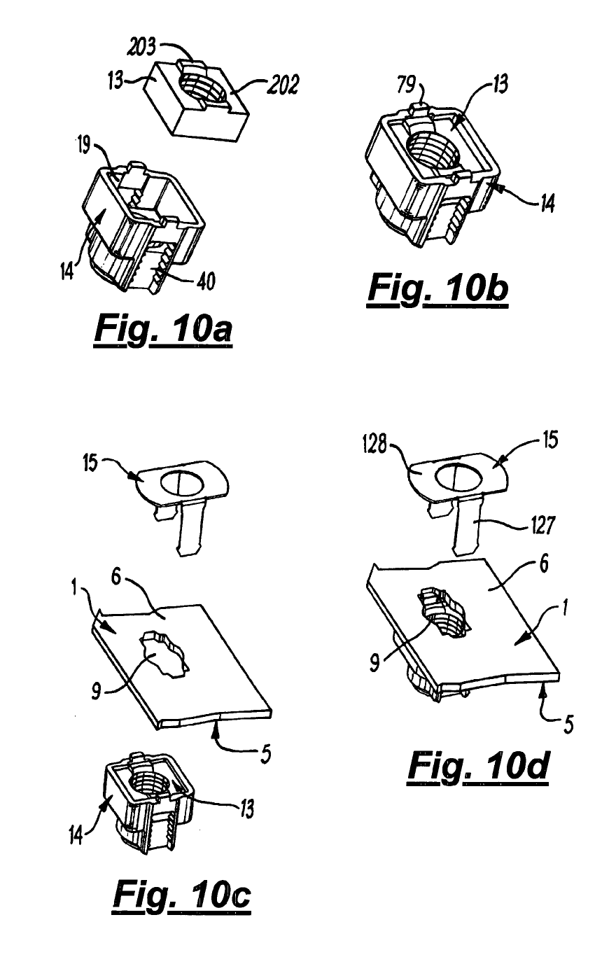

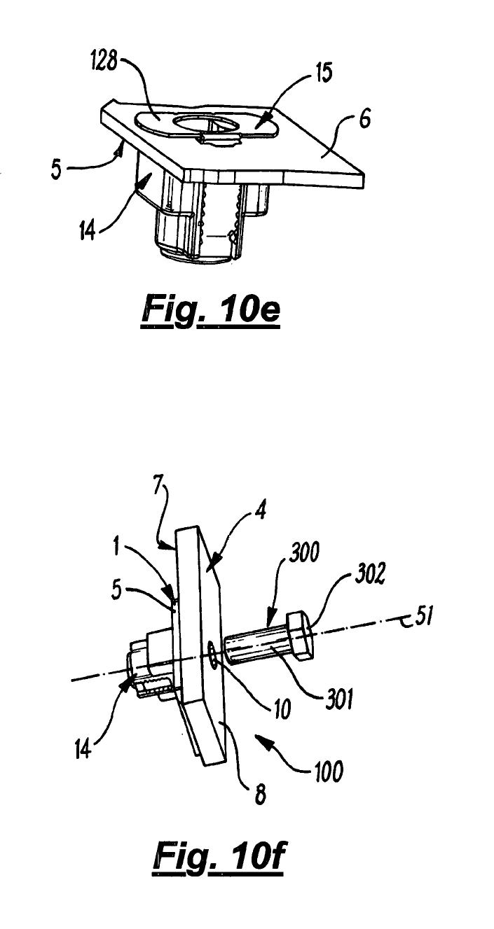

FIGS. 10a to 10e show the sequential steps in a method of attaching the fastener assembly of FIG. 1 to the first component of FIG. 1; and

FIG. 10f show the step of attaching a second component to the attached fastener assembly and first component produced by the method of FIGS. 10a to 10e, to form a component assembly.

Referring to FIG. 1 there is shown a front perspective view of a first component 1 fitted with a fastener assembly 2 according to the present invention.

The first component 1 is in the form of a first plate 1. The first plate 1 is elongate and extends in a thickness direction (‘t’) from a first surface 5 to a second surface 6. The first plate 1 is substantially flat and extends in a flat plane.

The first plate 1 is provided with a bore 9 that extends through the thickness of the plate 1 from its first surface 5 to its second surface 6. The bore 9 terminates as first and second apertures provided in the first surface 5 and the second surface 6 of the plate 1 respectively. The bore 9 is generally elongate and extends along a longitudinal axis 11. The longitudinal axis 11 of the bore 9 is substantially perpendicular to the plane in which the plate 1 extends. In this respect, the longitudinal axis 11 of the bore 9 is substantially perpendicular to the first and second surfaces 5, 6 of the first plates 1. The bore 9 is defined by an inner surface of the plate 1. The cross-sectional shape of the bore 9 will be described in further detail below.

The fastener assembly 2 comprises a retainer device 29 and a threaded nut 13 received within the retainer device 29 (see FIG. 6).

The retainer device 29 comprises a housing member 14 and support member 15. The housing member 14 comprises a generally thin walled body that defines a substantially hollow enclosure. The housing member 14 extends from a first end 16 to a second end 17 in an axial direction along a longitudinal axis 24 (see FIG. 2).

A first section of the housing member 14, that extends from the first end 16 of the housing member 14 to substantially half way along the axial length of the housing member 14, forms a nut receiving part 18 of the housing member 14. The nut receiving part 18 is a generally thin walled body that defines a substantially hollow cube centered on the longitudinal axis 24. The nut receiving part 18 is for receiving a threaded nut 13 (see below). The nut receiving part 18 has a first pair of opposed first and second surfaces 26, 27 that extend in a length direction of the housing member 14 (as well as in the axial direction 24) and a second pair of opposed first and second surfaces 61, 62 that extend in a width direction of the housing member 14 (as well as in the axial direction 24).

The first end 16 of the housing member 14 comprises a substantially square surface 20, facing outwardly in the axial direction 24, with a substantially square aperture 19 provided centrally in said surface 20. The surface 20 forms a substantially square rim around the aperture 19. The rim is substantially flat, lies in the plane of the aperture 19 and faces outwardly in the axial direction 24. The aperture 19 extends inwardly from the first end 16 of the housing member 14 in the axial direction 24, to a second section 21 of the housing member 14 (see below) to form a bore 31 of a substantially square cross section centered on the longitudinal axis 24 of the housing member 14.

A second section 21 of the housing member 14 extends from an end of the nut receiving part 18 that is distal to the first end 16 of the housing member 14, in the axial direction 24, to the second end 17 of the housing member 14.

The outer surface of the second section 21 has a generally cuboidal shape, having a substantially rectangular cross-sectional shape centered on the longitudinal axis 24. The outer surface has a first pair of opposed first and second surfaces 91, 92 that extend in the length direction of the housing member 14 (and the axial direction 24) and form the shorter sides of the rectangular cross-section of the outer surface.

The outer surface has a second pair of first and second opposed surfaces 93, 94 that extend in the width direction (and the axial direction) and form the longer sides of the rectangular cross-section of the outer surface.

The first pair of first and second opposed surfaces 91, 92 of the second section 21 are substantially parallel and substantially aligned, in the width direction of the housing member 14, with the first pair of first and second opposed surfaces 26, 27 of the nut receiving part 18 respectively. The first pair of first and second opposed surfaces 91, 92 of the second section 21 are shorter, in the length direction of the housing member 14, than the first and second opposed surfaces 26, 27 of the nut receiving part 18 respectively. Accordingly, the second pair of opposed surfaces 93, 94 of the second section 21 are spaced inwardly in the length direction of the housing member 14 from the second pair of opposed first and second surfaces 61, 62 of the nut receiving part 18.

The second pair of first and second opposed surfaces 93, 94 of the second section 21 are substantially parallel with the second pair of first and second opposed surfaces 61, 62 of the nut receiving part 18 respectively.

Each of the second pair of opposed surfaces 93, 94 of the second section 21 is provided with a radially outward extending bulge 22 (relative to the longitudinal axis 24). Each radially outward bulge 22 is centered substantially midway along the length of the respective surface 93, 94 in the width direction of the housing member 14.

The second section 21 is generally solid, provided with a bore 23 defined by a radially facing inner surface 400 of the second section 21 (see FIGS. 3 and 4). The bore 23 extends in the direction of the longitudinal axis 24 of the housing member 14 from a first end of the second section 21, that is proximal to the nut receiving part 18 of the housing member 14, to a second end that is axially inboard of the second end 17 of the housing member 14. An axially facing inner surface 401 of the second section 21 forms a rim around the bore 23.

Referring to FIG. 3, the bore 23 has a generally curved cross-sectional shape, centered on the longitudinal axis 24, provided with three lobed portions 25 distributed circumferentially about the axis 24. Each lobed section 25 is generally concave, centered on the axis 24. Intermediate portions 130 of the bore are provided between adjacent lobed portions 25. Each intermediate portion 130 is generally concave, centered on the axis 24 and has a smaller radius of curvature than each lobed portion 25. The lobed portions 130 and the intermediate portions 130 are arranged such that they are engageable with a bolt, as the bolt is screwed into a nut 13 received in the housing member 14, such that the housing member is attached to the bolt, as described below.

The radially outward extending bulge 22 in the second pair of opposed surfaces 93, 94 of the outer surface of the second section 21 accommodates the bore 23.

A first channel 40 is provided within, and extends along, the first surfaces 26, 91 of the first pair of opposed surfaces of the nut receiving part 18 and the second section 21 of the housing member 14. The channel 40 is provided substantially midway along the length of said first surfaces 26, 91 in the length direction of the housing member 14 and extends from the first end 16 of the housing member 14, in the axial direction 24, to the second end 17 of the housing member 14.

Similarly, a second channel 41 is provided within, and extends along the second surfaces 27, 92 of the first pair of opposed surfaces of the nut receiving part 18 and the second section 21 of the housing member 14. The channel 42 is provided substantially midway along the length of said second sides 27, 92 in the length direction of the housing member 14 and extends in a longitudinal direction from the first end 16 of the housing member 14, in the axial direction 24, to the second end 17 of the housing member 14.

Each channel 40, 41 has a substantially U-shaped cross sectional shape, having a base 95 and opposed surfaces 96. A longitudinal section of the base 95 is formed by the outer surface of the second section 22 of the housing member 14. A section of each channel 40, 41 that passes from the second end 17 of the housing member 14 to a position axially inboard of the first end 16 of the housing member 14 extends, in the width direction of the housing member 14, through the thickness of the wall of the housing member 14 to form an open channel 40, 41.

A section of each channel 40, 41 provided towards the first end 16 of the housing member 14 does not extend through the thickness of the wall of the housing member 14 such that said section of the channel 40, 41 is closed by said wall.

Each channel 40, 41 is provided with a plurality of teeth 101, distributed substantially along the length of the channel 40, 41 (in the axial direction 24) on the opposed surfaces 96 of the channel 40, 41.

First and second sides of the surface 20 of the first end 16 of the housing member 14, that are formed by the first and second surfaces 26, 27 of the nut receiving part 18 are provided, substantially midway along their length, with first and second protrusions 78, 79 respectively (see FIG. 6). The first and second protrusions 78, 79 extend outwardly from the surface 20 in the axial direction 24. The first and second protrusions 78, 79 have a generally trapezoidal cross sectional shape about said axis 24.

Referring now to FIGS. 7 and 8, the support member 15 comprises a substantially flat plate 121 that extends in a thickness direction from a first surface 127 to a second surface 128. The first and second surfaces 127, 128 are substantially flat. The plate 121 extends substantially within a plane. The plate 121 has a first pair of opposed first and second sides 122, 123, that are substantially straight and substantially parallel to each other.

The first pair of first and second sides 122, 123 are bounded at either end by a second pair of first and second sides 124, 125. The second pair of first and second sides walls 124, 125 are concavely curved about the centre of the plate 121.

A substantially circular bore 500 is provided in the centre of the plate 121 and extends from the first surface 127 of the plate 121 to the second surface 128. The bore 500 is sized and dimensioned to allow the passage of a bolt for the nut 13.

The support member 15 further comprises first and second tongues 126, 127 provided substantially midway along the length of the first and second parallel sides 122, 123 of the plate 121. The first and second tongues 126, 127 are generally elongate and extend substantially perpendicular to the plane of the plate 121 along a longitudinal axis. The first and second tongues 126, 127 are substantially perpendicular to the first surface 127 of the plate 121.

Each tongue 126, 127 extends from a first end 129, attached to the first and second sides 122, 123 of the plate 121 respectively, to a second end that is distal to the plate 121. The second end of each tongue 126, 127 forms a protrusion 130.

Each protrusion 130 has a generally trapezoidal shape, having an upper surface 131 that extends substantially parallel to the first or second parallel sides 122, 123 of the plate 121 respectively bounded on either side by first and second side surfaces 132 that extend in the axial direction of the tongue 126, 127 at an angle of approximately 45° relative to said axial direction. Each side surface 132 forms a lip 133 where it joins the lower portion of the tongue 126, 127.

Referring now to FIG. 5 there is shown the nut 13 of the fastener assembly 2. The nut 13 is an internally threaded square nut. However, it will be appreciated that a nut of any suitable shape may be used.

The nut 13 comprises a threaded cylindrical bore 200 that extends from a first surface 201 to a second surface 202 of the nut 13 along a longitudinal axis 204. The second surface 202 of the nut 13 is provided with first and second protrusions 203. The first and second protrusions 203 are radially opposed to each other about said axis 204. Each protrusion 203 protrudes from the second surface 202 of the nut 13 in the axial direction 204. Each protrusion 203 has a generally rectangular cross-sectional shape about said axis but the longer sides of the rectangle that are proximal to the axis 204 are concavely curved about said axis 204.

Referring to FIG. 9, there is shown a plan elevational view of the first plate 1. The bore 9 in the first plate 3 terminates at the first surface 5 of the first plate 3 as an aperture 12. The bore 9 has a generally rectangular cross-sectional shape, about its axis 11 where each side of the rectangle is provided with a radially outward extending bulge 210, 211 (relative to the axis 11). Each radially outward bulge 210, 211 is centered substantially midway along the length of the respective side of the rectangle.

Each bulge 210 provided on the longer sides of the rectangular cross-sectional shape is concavely curved about said axis 11. The region bordered by the bulge 210 is to accommodate a bolt for the nut 13.

Each bulge 211 of the shorter sides of the rectangular cross-sectional shape of the bores 9, 10 has a radially outer section 212 and a radially inner section 213 (relative to the axis 11 of the bore 9).

Each radially outer section 212 has a generally trapezoidal shape and is shaped to form a close fit with the first or second protrusions 78, 79 of the surface 20 of the first end 16 of the housing member 14 respectively, such that when a bolt is screwed into the nut (see below) the engagement of the inner surface of the plate 1 that defines the radially outer section 212 engages with the first or second protrusions 78, 79 respectively, so as to prevent the housing member 14 from rotating relative to the first plate 3.

Each radially inner section 213 is shaped to receive the first or second protrusions 203 of the nut 13 respectively, such that when a bolt is screwed into the nut 13 (see below) the engagement of the inner surface of the plate 1 that defines the radially inner section 213 engages with the first or second protrusions 203 respectively, so as to prevent the nut 13 from rotating relative to the first plate 1.

Referring now to FIGS. 10a to 10e there is shown the sequential steps in a method of attaching the fastener assembly 2 to the first plate 1. As shown in FIGS. 10a and 10b, as a first step the nut 13 is received within the aperture 19 provided in the surface 20 of the first end 16 of the housing member 14, into said bore 31. The aperture 19, and bore 31, are sized and dimensioned so that the nut 13 may be received through the aperture 19 into the nut receiving part 18 of the housing member 14. When the nut 13 is received within the nut receiving part 18 of the housing member 14, the first surface 201 of the nut 13 contacts the axially facing inner surface 401 of the second section 21. The second surface 202 of the nut 13 faces out of the aperture 19. The first and second protrusions 203 of the nut 13 are positioned radially adjacent to, and inwardly of, the first and second protrusions 78, 79 of the surface 20 of the first end 16 of the housing member.

Referring now to FIGS. 10c to 10d, once the nut 13 is received within the nut receiving part 18 of the housing member 14, the housing member 14 is then mounted on the first surface 5 of the first plate 1 such that the surface 20 at the first end 16 of the housing member 14 is in contact with the first surface 5 of the first plate 1. The housing member 14 is mounted over the bore 9. The second surface 202 of the nut 13, that faces out of the aperture 19, also contacts the first surface 5 of the first plate 1.

When the housing member 14 is mounted on the first surface 5 of the first plate 1, the first and second protrusions 78, 79 of the housing member 14 are received within the radially outer sections 212 of the bore 9, to form said close fit. In addition, the first and second protrusions 203 of the nut 13 are received within the radially inner sections 213 of the bore 9, to form said close fit.

The support member 15 is then attached to the housing member 14 from the side of the second surface 6 of the first plate 1. Specifically, the tongues 126, 127 of the support member 15 are passed through the radially inner sections 213 of the bore 9 and are slidably received within the first and second channels 40, 41 respectively, passing between the first and second protrusions 203 of the nut 13 and the first and second protrusions 78, 79 of the housing member 14.

When the tongues 126, 127 are received within the channels 40, 41 the first surface 127 of the plate 121 of the support member 15 is opposed to the surface 20 of the first end 16 of the housing member 14.

As each tongue 126, 127 is received within the respective channel 40, 41, the protrusion 130 of the tongue 126, 127 engages with the teeth 101 of the channel 40, 41. The protrusions 130 are engageable with the teeth 101 in a plurality of axial positions such that the distance between the opposed surfaces 127, 20 of the support member 15 and the housing member 14 is varied.

As the tongues 126, 127 are received further within the channels 40, 41 the first surface 127 of the support member 15 approaches said surface 20 of the first end 16 of the housing member 14 until said surface 127 of the support member 15 abuts against the second surface 6 of the first plate 1. This attaches the housing member 14 to the first plate 1 by clamping the first plate 1 between said surface 20 of the first end 16 of the housing member 14 and the first surface 127 of the plate 121 of the support member 15. Accordingly, the housing member 14 is retained in position, relative to the bore 9 by the support member 15.

Because the protrusions 130 are engageable with the teeth 101 in a plurality of positions, such that the distance between the opposed surfaces 127, 20 of the support member 15 and the housing member 14 is varied, this enable the fastener assembly 2 to accommodate different thicknesses of the first plate 1.

In this respect, the protrusion 130 forms a ratcheted engagement with the teeth 101 such that the tongues 126, 127 may be received further within the channels 40, 41, so as to reduce the distance between the opposed surfaces 127, 20 of the support member 15 and the housing member 14 but are prevented from being removed back out of the channels 40, 41, so as to increase the distance between said opposed surfaces 127, 20. This is advantageous in that is allows the distance between the opposed surfaces 127, 20 to be varied, so as to accommodate different thicknesses of the first plate 1, while still maintaining the clamping force of the opposed surfaces so as to retain the housing member 14 on the first plate. In the described embodiment the fastener assembly 2 can be used with a first plate having a thickness in the range 2 to 12 mm. It will be appreciated that, through appropriate design, different thickness ranges could be accommodated.

Referring now to FIG. 10f, there is shown a method of attaching a second component 4, in the form of a second plate 4 to the attached fastener assembly 2 and first plate 1 to form a component assembly 100.

The second plate 4 is elongate and extends in a thickness direction from a first surface 7 to a second surface 8. The plate 3 4 is substantially flat and extends in a respective plane.

The second plate 4 is provided with a substantially cylindrical bore 10 that extends through the thickness of the plate 4 from its first surface 7 to its second surface 8. The bore 10 terminates as first and second apertures provided in the first and second surfaces 7, 8 of the plate 4. The bore 10 is generally elongate and extends along a longitudinal axis 51. The longitudinal axis 51 the bore 10 is substantially perpendicular to the plane in which the plate 4 extends. In this respect, the longitudinal axis 51 of the bore 10 is substantially perpendicular to the first and second surfaces 7, 8 of the second plate 4. The bore 10 is defined by an inner surface of the plate 4.

In order to attach the first and second plates 1, 4 together, to form a component assembly 100, the first and second plates 1, 4 are placed adjacent to each other such that the second surface 6 of the first plate 1 is adjacent and opposed to the first surface 7 of the second plate 4, with the bores 9, 10 of the first and second plates 1, 4 substantially aligned. The first and second plates 1, 4 are substantially parallel to each other and extend in a common plane. The plate 121 of the support member 15 is disposed between the second surface 6 of the first plate 1 and the first surface 7 of the second plate 4.

The bores 9, 10 in the first and second plates 3, 4 form a substantially continuous bore. A shaft 301 of a threaded bolt 300 is then passed through the aperture in the second surface 8 of the second plate 4, through the bore 10 in the second plate 4, through the bore 500 in the plate 121 of the support member 15, through the bore 9 in the first plate 1 and into engagement with the nut 13 in the housing member 14. As the bolt 300 is screwed into the nut 13, the first and second plates 1, 4 are clamped together, between a head 302 of the bolt 300 and the second surface 202 of the nut 13.

As the bolt 300 is screwed into the nut 13, the shaft 301 of the bolt 300 extends past the first surface 201 of the nut 13 and engages with the bore 23 in the second section 21 of the housing member 14.

Specifically, the threaded section of the bolt engages with the radially facing inner surface 400 of the second section 21 that defines the lobed portions 25 and the intermediate portions 130 of the bore 23. As the bolt 300 rotates it cuts a thread into the lobed portions 25. This is advantageous in that it fixedly attaches the housing member 14 to the bolt 300, which prevents the bolt working loose in use due to vibration. This removes the need to use a conventional locking device such as a ‘Nyloc Nut’, which could not be welded to the first plate 1 as heat from the welding would melt the plastic locking mechanism of the nut.

The housing member 14 forms an enclosure that substantially encloses the nut 13, apart from the second surface 202 of the nut 13. This is advantageous in that it prevents corrosion of the nut 13. The housing member is made from High-density polyethylene (HDPE). However, it will be appreciated that it may be made from any corrosion resistant material. The housing member may be made from a material suitable for injection moulding such as Acrylonitrile-Butadiene-Styrene ABS, Nylon PA, Polycarbonate PC, Polypropylene PP, Polystyrene GPPS, or light metal alloys, for example.

In view of the above, it can be seen that the retainer device 29 provides a retainer device for positioning a threaded nut relative to a bore in a first component, for attachment of a threaded bolt, that is able to accommodate different thicknesses of the first component. The retainer device also protects the nut from corrosion.

In the described embodiment, the first plate 1 is a side plate of a tow bar frame and the second plate 4 is a plate of vehicle chassis.

The described and illustrated embodiments are to be considered as illustrative and not restrictive in character, it being understood that only the preferred embodiments have been shown and described and that all changes and modifications that come within the scope of the inventions as defined in the claims are desired to be protected.

For example, in the above described embodiment the housing member 14 is provided with the first and second channels 40, 41 and the support member 15 is provided with first and second tongues 126, 127 that are slidably engageable with the first and second channels 40, 41 of the housing member 14. Alternatively, in a reciprocal arrangement, the first and second channels 40, 41 may be provided in the support member 15, with the tongues 126, 127 provided on the housing member 14.

Furthermore, in the above described embodiment the first and second channels 40, 41 are provided with a plurality of teeth 101 distributed in the length direction of the channel 40, 41. Each tongue 126, 127 is provided with a single protrusion 130 that is engageable with the teeth 101 in a plurality of axial positions. Alternatively, each channel 40, 41 may be provided with a single tooth or groove, with each tongue 126, 127 provided with a plurality of protrusions, teeth, or grooves that are engageable with the teeth or groove of the first and second channels 40, 41 in a plurality of axial positions.

In the described embodiment, the first and second components are first and second plates 1, 4. However it will be appreciated that the first and second components may be any type of component that can be attached to each other, including a block, or any other component. In addition, in the described embodiment the plate 1 is a side plate of a tow bar and the second plate 4 is a plate of vehicle chassis. Alternatively, the plate 1 may be a plate of vehicle chassis and the second plate 4 may be a side plate of a tow bar.

1-40. (canceled)

41. A retainer device, for positioning a threaded nut relative to a bore in a component for attachment of a threaded bolt, comprising a housing member for receiving a threaded nut and a support member that is attachable to the housing member so as to attach the housing member to the component by clamping the component between opposed surfaces of the housing member and the support member, wherein the support member is attachable to the housing member in a plurality of positions in which the distance between the opposed surfaces of the support member and the housing member is varied.

42. A retainer device according to claim 41 wherein the housing member is provided with an aperture through which a surface of a nut received within the housing member is contactable with the component.

43. A fastener assembly comprising a retainer device according to claim 41 and a threaded nut received in the housing member of the retainer device.

44. A fastener assembly according to claim 43 wherein the retainer device is provided with an aperture through which a surface of the nut received within the housing member is contactable with the component, wherein the surface of the nut that is contactable with the component through the aperture in the housing member is provided with at least one protrusion for receipt within a bore in the component so as to prevent rotation of the nut relative to the component when a bolt is screwed into the nut.

45. A retainer device according to claim 41 wherein the housing member comprises a first engagement member and the support member comprises a second engagement member, wherein the first and second engagement members are engageable with each other in a plurality of positions such that the support member is attachable to the housing member in said plurality of positions.

46. A retainer device according to claim 45 wherein the first engagement member comprises at least one channel and the second engagement member comprises at least one tongue that is slidably receivable within the at least one channel.

47. A retainer device according to claim 46 wherein the at least one channel comprises first and second channels and the at least one tongue comprises first and second tongues that are slidably receivable within the first and second channels respectively.

48. A retainer device according to claim 46 wherein the at least one channel is provided with a plurality of formations distributed along the length of the channel and the at least one tongue is provided with at least one co-operating formation that is engageable with the plurality of formations such that the support member is attachable to the housing member in said plurality of positions.

49. A retainer device according to claim 41 wherein the support member is attachable to the housing member such that the opposed surfaces of the housing member and support member are movable towards each other, to said plurality of positions, but are prevented from moving away from each other by the engagement of the first and second engagement members.

50. A retainer device according to claim 41 wherein the housing member is provided with at least one protrusion for engagement with a bore in the component so as to prevent rotation of the housing member relative to the component when a bolt is screwed into a nut received within the housing member.

51. A component fitted with a fastener assembly according to claim 43 wherein a bore is provided in the component that extends from a first surface to a second surface of the component, the housing member of the fastener assembly is mounted to the first surface of the component such that a surface of the housing member contacts said first surface and the support member of the fastener assembly is attached to the housing member such that a surface of the support member is opposed to the surface of the housing member and contacts the second surface of the component such that the housing member is attached to the component by clamping the component between said opposed surfaces of the housing member and support member.

52. A component fitted with a fastener assembly according to claim 51 wherein the housing member of the retainer device of the fastener assembly is provided with at least one protrusion for engagement with a bore in the component so as to prevent rotation of the housing member relative to the component when a bolt is screwed into a nut received within the housing member, and wherein the bore of the component has at least one first section that is shaped to receive the at least one protrusion of the housing member so as to prevent rotation of the housing member relative to the component when a bolt is screwed into the nut.

53. A component fitted with a fastener assembly according to claim 52 wherein the retainer device of the fastener assembly is provided with an aperture through which a surface of the nut received within the housing member is contactable with the component, wherein the surface of the nut that is contactable with the component through the aperture in the housing member is provided with at least one protrusion for receipt within the bore in the component so as to prevent rotation of the nut relative to the component when a bolt is screwed into the nut, and wherein the bore of the component has at least one second section that is shaped to receive the at least one protrusion on said surface of the nut so as to prevent rotation of the nut relative to the component when a bolt is screwed into the nut.

54. A retainer device according to claim 51 wherein the housing member comprises a formation that is engageable with the bolt as the bolt is screwed into a nut received in the housing member such that the housing member is attached to the bolt.

55. A retainer device according to claim 54 wherein the formation is a bore, the bore having a generally curved cross sectional shape provided with at least one lobed portion.

56. A retainer device according to claim 54 wherein the bore is provided with a plurality of said lobed portions distributed in the circumferential direction of the cross sectional shape of the bore.

57. A retainer device according to claim 42 wherein the aperture is arranged such that a nut is receivable into the housing member through the aperture, and wherein the housing member forms an enclosure that substantially encloses a nut received within the housing member apart from a surface of the nut that contacts the component through the aperture.

58. A component assembly comprising a component fitted with a fastener assembly according to claim 43 wherein said component forms a first component, and a second component provided with a bore that extends from a first surface to a second surface of the component, wherein the first and second components are arranged such that the second surface of the first component is adjacent and opposed to the first surface of the second component and their respective bores are in alignment, wherein a bolt passes from the side of the second surface of the second component through the aligned bores into engagement with the nut received within the housing member.

59. A component assembly according to claim 58 wherein the housing member of the retaining device comprises a formation that is engageable with the bolt as the bolt is screwed into a nut received in the housing member such that the housing member is attached to the bolt, and wherein the bolt is engaged with the formation of the housing member.

60. A method of attaching a fastener assembly according to claim 43 to a component provided with a bore that passes from a first surface to a second surface of the component, the method comprising the steps of mounting the housing member to the first surface of the component, attaching the support member to the housing member and adjusting the separation of the opposed surfaces of the housing member and support member such that the housing member is attached to the component by clamping the component between the opposed surfaces of the housing member and the support member.

61. A method according to claim 60 wherein the housing member of the retainer device is provided with at least one protrusion for engagement with a bore in the component so as to prevent rotation of the housing member relative to the component when a bolt is screwed into a nut received within the housing member, and wherein the at least one protrusion of the housing member is received within at least one first section of the bore in the component.

62. A method according to claim 60 wherein the retainer device of the fastener assembly is provided with an aperture through which a surface of a threaded nut received within the housing member is contactable with the component, wherein the surface of the nut that is contactable with the component through the aperture in the housing member is provided with at least one protrusion for receipt within a bore in the component so as to prevent rotation of the nut relative to the component when a bolt is screwed into the nut, and wherein at least one protrusion on the nut is received within at least one second section of the bore in the component.
